(19) United States
(12) Patent Application Publication
(10) Pub. No.: US 2002/0091956 A1
(43) Pub. Date: Jul. 11, 2002

(54) Methods and systems for reducing power consumption in computer data communications

(76) Inventors: Scott T. Potter, Norwalk, CT (US); Robert M. Unnold, Stamford, CT (US)

Correspondence Address: FISH & NEAVE, 1251 AVENUE OF THE AMERICAS, 50TH FLOOR, NEW YORK, NY, 10020-1105, US

(21) Appl. No.: 09/995,991

(22) Filed: Nov. 16, 2001

Related U.S. Application Data
(60) Provisional application No. 60/249,833, filed on Nov. 17, 2000.

(51) Int. Cl. G06F 13/00; G06F 9/00

(52) U.S. Cl. 713/324; 710/32; 710/35; 709/106

(57) ABSTRACT

Methods and systems for reducing power consumption in data communications is presented. Portable devices that interface with peripheral devices reduce power consumption by minimizing the time that a communications port is open. Rather than keeping the communications port open for the duration of a program, the communications port is opened at calculated times to allow bursts of data to pass through and closed in response to certain events. This invention also works with normal power cycling methods of portable devices and peripheral devices to produce even further power savings.

### CROSS REFERENCE TO RELATED APPLICATION

This application claims the benefit of United States Provisional Application No. 60/249,833, filed Nov. 17, 2000.

### BACKGROUND OF THE INVENTION

This invention relates to methods and systems for reducing power consumption in computers. More particularly, this invention relates to methods and systems for reducing power consumption in computers that communicate with peripheral devices.

Computer data communications involve an exchange or flow of data between two electronic devices such as a computer (in particular a portable device) and a peripheral device. Data is typically in the form of binary data and can include textual, video, or audio communications, or a combination of the same. The flow of data between the computer and the peripheral device occurs over a communications path and can flow as a continuous stream or in bursts.

A Global Positioning System (GPS) receiver is one example of a peripheral device that can communicate with a computer. GPS receivers obtain position information, which may be used to control geo-spatial data or mapping information, from GPS satellites that orbit the earth. This position information may be obtained by drawing power from the computer. GPS receivers are being widely used with standard computer platforms, such as personal computers, laptop computers, handheld computers (e.g., Personal Digital Assistants (PDAs)), and automobile computers. GPS receivers can communicate with these computers via a communications link and a communications port at the computer.

Power consumption is a problem particularly for portable devices. For example, battery-operated handheld devices typically have a limited operating time due to a short battery life. There are several sources of power consumption in portable devices. The greatest source of power consumption is the normal operating mode of a portable device. When the portable device is “ON,” power is being consumed. To minimize power consumption, many portable devices have an automatic power cycling feature that automatically puts its power cycle into sleep mode after a period of user interface inactivity (e.g., two minutes). This period can be configured in some devices by the user and results in large power savings. However, portable devices typically disable this automatic power cycling feature to receive data (generally for a continuous data stream) from peripheral devices.

Many times, the automatic power cycle feature will not trigger the sleep mode while an application or software thread is running on the computer. Prior to entering the sleep mode, the application or software thread must be suspended. A software thread may, for example, manage the flow of data through a communications port, and the opening and closing of the communications port to support communications between a computer and a peripheral device. Typically, such a software thread opens the communications port at the start of a program and closes the communications port when the program terminates. As a result, the running of the software thread consumes power for the duration of the program and the peripheral device also draws power for the duration of the program (until the communications port closes) regardless of whether data is being communicated between the computer and the peripheral device. For data that flows in bursts, power consumption is particularly wasteful due to periods of inactivity on the communications path between bursts.

In view of the foregoing, it would be desirable to provide methods and systems for reducing power consumption in computers that communicate with peripheral devices.

### SUMMARY OF THE INVENTION

It is an object of the present invention to provide methods and systems for reducing power consumption in computers that communicate with peripheral devices. Various embodiments and features of the present invention are described, for example in United States Provisional Application No. 60/249,833, filed Nov. 17, 2000, which is hereby incorporated by reference herein in its entirety.

In various embodiments of the present invention, communications ports, through which computers (such as, for example, handheld computers) may communicate with a peripheral device (such as, for example, GPS receivers), are configured to minimize the time that the ports are open and to work with normal power cycling methods of portable devices and peripheral devices. A software thread in the portable device attempts to synchronize the opening and closing of the communications port with the transmission of data from the peripheral device to the computer. For example, a computer can use a read function to attempt to read a large amount of data from a peripheral device via a communications port. The communications port may be open for a brief length of time as data bursts from the peripheral device are received.

Prior to reading a burst of data from a peripheral device, several things need to occur. First, a software thread must be initiated. Next, a communications port needs to be initialized and any buffers used for temporary storage during the processing and storing of data needs to be cleared. The communications port may then be opened and data from the peripheral device may be read.

In some embodiments, a detect function may signal when an “end-of-frame” is received. In cases where the size of a data burst frame is known, the software thread may close the communications port once the last character of the frame is read, and enter a suspend mode.

In some embodiments, a detect function may signal when an “interval timeout” occurs. An interval timeout occurs when a time interval between two successive character transmissions exceeds a predetermined threshold value, indicating an end of the data burst. In response to an interval timeout, the software thread may close the communications port and enter a suspend mode.

For both the end-of-frame and interval timeout embodiments, the software thread may calculate a timer value and start a timer prior to entering a suspend mode. The timer may be set to a time until a next data burst is ready to be read. For data bursts that flow in regular time intervals, the timer value may be calculated after an initial data burst and assigned the same timer value for every data burst thereafter. In still another approach, the timer value may be calculated after each data burst. For more variable data bursts, the software thread can determine a timer value for a next burst of data based on the timing values of prior bursts of data. When a next data burst is ready to be read (and the timer expires), the software thread may resume (i.e., leave suspend mode) and open the communications port.

In some embodiments, a detect function may signal when an “overrun error” occurs. An overrun error occurs when a requested number of characters is read. Typically, this requested number of characters is set to a maximum number of characters that can be stored in buffers that are used during the processing and storing of data. In response to an overrun error, the software thread may close the communications port. The communications port may then be initialized and the buffers cleared before the communications port is reopened to read the data burst.

In some embodiments, a detect function may signal when a “power event” occurs. A power event may indicate that the power cycle of the computer has entered sleep mode (i.e., the computer has turned “OFF”). Once the computer powers up (i.e., turns back “ON”), the software thread may resume and open the communications port. The software thread may continue where it left off prior to the power event by reading the rest of the data burst.

In various embodiments, one or more of the end-of-frame, interval timeout, overrun error, and power event features may be used to detect an end of a data burst. In each of these techniques, the software thread may synchronize the opening and closing of the communications port and the resuming and suspending of the software thread with the flow of data from the peripheral device. Once the communications port is closed and the software thread is suspended, the computer may enter a sleep mode after a period of user inactivity.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative arrangement for a computer and peripheral device in accordance with one embodiment of the present invention;

FIG. 2 illustrates a timing diagram for reading communications port data in accordance with one embodiment of the present invention;

FIG. 3 illustrates a flow diagram of a read function that detects an end-of-frame event in accordance with one embodiment of the present invention;

FIG. 4 illustrates a flow diagram of a read function that detects an interval timeout in accordance with one embodiment of the present invention;

FIG. 5 illustrates a flow diagram of a read function that detects an overrun error in accordance with one embodiment of the present invention;

FIG. 6 illustrates a flow diagram of a read function that detects a power event in accordance with one embodiment of the present invention; and

FIG. 7 illustrates a flow diagram of a process of reading communications port data in accordance with one embodiment of the present invention.

### DETAILED DESCRIPTION OF THE INVENTION

The present invention provides methods and systems for reducing power consumption in computers that communicate with peripheral devices. Aspects of the invention apply to different types of personal computers, portable devices such as laptop computers and handheld devices (e.g., personal digital assistants (PDAs), cellular telephones, and peripheral devices (e.g., Global Positioning System (GPS) receivers, wireless modems, digital attachments such as voice recorders and cameras). For purposes of illustration and not by way of limitation, various features of the present invention are primarily described herein in the context of portable devices and GPS receivers.

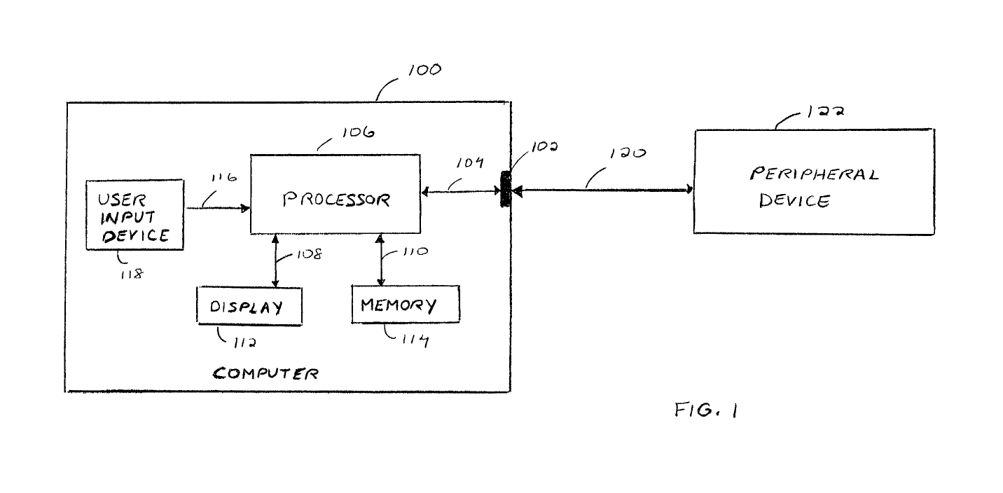

FIG. 1 shows an illustrative arrangement for a computer 100 that communicates with a peripheral device 122. Computer 100 may be any device suitable for communicating with peripheral device 122. In some embodiments of the invention, device 100 may have a relatively large amount of storage capacity (e.g., 256 Megabytes (MB), 512 MB, 4 Gigabytes (GB)) and processing power (e.g., 500 Megahertz (MHz), 1.0 Gigahertz (GHz)). In other embodiments, device 100 may have a relatively small amount of storage capacity (e.g., 8 MB, 16 MB) and processing power (e.g., 33 MHz, 233 MHz).

Computer 100 may include a processor 106, which may have a variety of functions. Processor 106 may handle all input and output (I/O) data between computer 100 and peripheral device 122. A user may control computer 100 by sending commands to processor 106 using a user input device 118 connected to processor 106 via a data link 116. User input device 118 may be a pointing device, a wireless remote control, a keyboard, a touch-pad, a voice recognition system, or any other suitable user input device. A user may, for example, enter a command by clicking on a program icon with a pointing device, using a touch-pad to select a command, etc.

In response to a user command, processor 106 may obtain data from communications port 102 via a data link 104. In other embodiments, processor 106 may obtain data automatically from communications port 102 via data link 104. Processor 106 may process input data obtained from communications port 102 by storing the data in a memory 114 via a data link 110 in any suitable format. Memory 114 may be any suitable storage device, such as a random access memory (RAM), a read only memory (ROM), a flash memory, a hard disk drive, a combination of such devices, etc. Processor 106 may also process input data obtained from communications port 102 or from memory 114 by rendering the data on a display screen 112 via a data link 108 in any suitable format. Display screen may be any suitable display device, such as a television screen, a computer monitor, a screen on a handheld device, a screen on a cellular telephone, etc. Data links 104, 108, 110, and 116 may be any suitable link, such as a data bus, that allows the transfer of data.

Processor 106 may also handle program threads used for managing the operation of a computer and applications within the computer. For example, processor 106 may manage a software thread to control the opening and closing of communications port 102. When there is no data activity from peripheral device 122, processor 106 may direct the software thread to close the communications port and then suspend the software thread. As another example, processor 106 may manage a main program thread to direct the operation of computer 100. After a period of user inactivity on computer 100, processor 106 may direct the main program thread to close all applications and communications ports, and suspend all other threads before suspending the main program thread so that computer 100 can enter a sleep mode.

Computer 100 may connect to peripheral device 122 via communications port 102 and a communications link 120. Communications port 102 may be a serial port, a parallel port, a Universal Serial Bus (USB) port, IEEE 1394 (Firewire), or any other suitable communications port. Communications link 120 may be a copper wire or any other suitable medium for transferring data. Data may be transferred along communications link 120 serially, in parallel, or in any other suitable method for transferring data.

Peripheral device 122 may be a Global Positioning System (GPS) receiver or any other device which may provide data to computer 100. A peripheral device such as a GPS receiver generally operates in one of two modes: continuous operating mode and trickle power mode. In continuous operating mode, the GPS receiver is constantly “ON” and draws a steady amount of power (e.g., on the order of a hundred milliamps) from the computer. In trickle power mode, the GPS receiver is “ON” when position information is being obtained (and draws power from the computer on the order of, for example, a hundred milliamps). When the GPS receiver is not obtaining position information, the GPS receiver typically enters a low power sleep mode (e.g., draws power on the order of, for example, five hundred microamps). GPS receivers that operate in trickle power mode obtain position information at regular time intervals (e.g., typically every three seconds). The frequency with which position information is obtained by the GPS receiver may be user configurable.

Peripheral device 122 may provide data non-continuously to computer 100. For example, peripheral device 122 may send data to computer 100 in bursts at regular time intervals, or at variable time intervals. Because data is not sent as a continuous data stream over communications link 120, communications port 102 may be opened during periods of data activity and closed during periods of data inactivity. When data bursts are short and the time interval between bursts is long, power savings may be achieved because the port may be closed during the long time intervals between bursts.

When a computer powers up (i.e., turns “ON”), a software thread is initiated and the timing cycle of the communications port attempts to synchronize with the timing cycle of the peripheral device. For a peripheral device that runs in trickle power mode, the software thread attempts to manage the opening and closing of the communications port in response to the peripheral device receiving and sending data to the computer. The software thread can be designed to open the communications port immediately prior to a beginning of a data burst from the peripheral device and to close the communications port immediately after the end of the data burst. Once the communication port closes, the software thread can be suspended until a next burst of data is ready to be read, resulting in additional power savings.

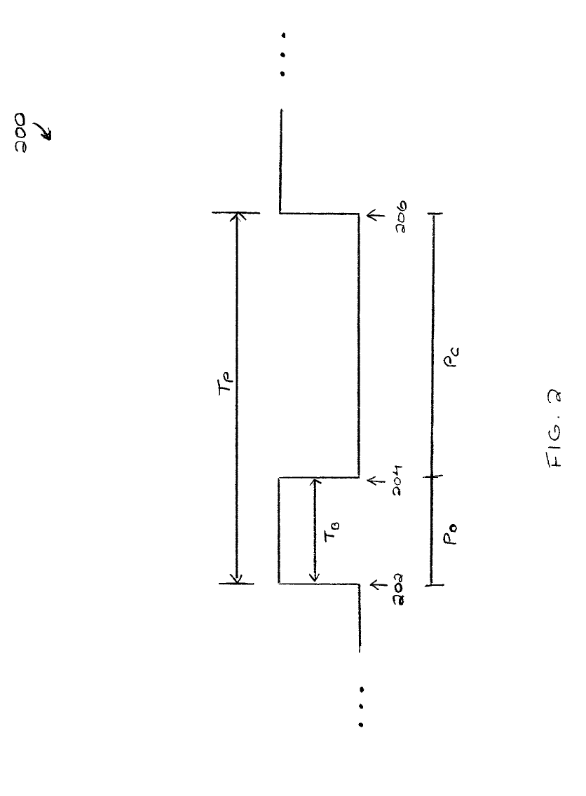

FIG. 2 illustrates a timing diagram 200 for reading communications port data. A period (T_{P}) can be a time measured from a beginning of a burst 202 to a beginning of a subsequent burst 206. The duration of a data burst (T_{B}) can be a time from a beginning of a burst 202 to an end of the same burst 204. The duration of a data burst (T_{B}) can be the same for each burst or different with each burst. Similarly, the duration between bursts (T_{P}−T_{B}) can be the same or different.

Within the period (T_{P}), there may be a time interval that the communications port is open (Pₒ) and a time interval that the communications port is closed (P_{c}). In synchronizing the timing cycle of the software thread with the timing cycle of the peripheral device, the communications port is made to open prior to the beginning of the data burst 202 and to close after the end of the data burst 204. The communications port may be open (Pₒ) for longer than this burst time (T_{B}), depending on how accurately the software thread calculates a time until a next data burst and how quickly it detects the end of a data burst. When the communications port is open, power is consumed by the software thread and the peripheral device. When the communications port is closed, the software thread is suspended and little power is being consumed.

In some embodiments, power savings may be achieved by the low-power suspend mode of the software thread after the communications port closes when, for example, Pₒ is short and P_{c} is long (i.e., long time intervals between bursts). For such embodiments, the automatic power cycling feature of a portable device does not have to be disabled. As a result, the power cycle in these portable devices can enter sleep mode (i.e., turn “OFF”) after a configured period of user interface inactivity. Prior to entering sleep mode, any communications ports close and any thread (e.g., the software thread) enters a suspend mode. This may result in additional power savings. Power savings may be further realized by the low power sleep mode (e.g., trickle power mode) present in some peripheral devices. For example, when GPS receivers do not obtain position information, the receivers enter sleep mode and draw less power from portable devices while the communications port is still open.

The communications port may be managed to prevent loss of data. For example, the timing cycle of the portable device may be synchronized with the timing cycle of the peripheral device so that when data is sent to the handheld device from the peripheral device, the communications port in the portable device is open at least for the duration of the transmission of a burst of data. The portable device may use a timer to predict when to open and close the communications port. The more accurate these timings are predicted, the greater the power savings may be.

For burst data that is transmitted at regular time intervals, a timer value may be calculated after an initial data burst. After each subsequent data burst, the timer may be set to the same value. A new timer value can also be calculated after every data burst or after every few bursts. These calculations may be used as a check to verify the accuracy of the timing cycle of the software thread to provide updated timer values.

The timer value, or time interval in which the communications port is to remain closed, may be calculated from the data period T_{P} (time difference between two successive types of interval timeouts) minus the data burst time T_{B} as illustrated in FIG. 2. The burst time may be calculated as a number of characters received in a burst divided by a baud rate of the data, where the baud rate is the number of characters transmitted per second.

In other embodiments, burst data may be transmitted at variable time intervals. The software thread may be designed to reconfigure the frequency with which a peripheral device receives and sends data to the computer. Similar to the approach in which burst data is transmitted at regular time intervals, the software thread may attempt to synchronize the communications port with the changes in the transmission of burst data from the peripheral device. Called “smart power,” a portable device may want to dynamically change the frequency with which a portable device obtains and transmits data. For example, a GPS receiver may receive position information and provide the position information to the portable device at regular time intervals (e.g., every three seconds). When the position of the device changes more often, the portable device may obtain position information more often (e.g., every second). Similarly, when the position of the device is changing less often, the portable device may obtain position information less often (e.g., every ten seconds).

The software thread in the portable device may detect this change in position. For example, the software thread may signal when a velocity condition is below a predetermined value or above another predetermined value. The velocity condition can be computed as a change in position between data from two successive data bursts (i.e., a distance) divided by a time interval between the two data bursts. When the software thread detects a low velocity condition, position may be changing less often. The software thread may then reconfigure the GPS receiver to obtain position information less frequently. Similarly, when the software thread detects a high velocity condition, position may be changing more often. The software thread may then reconfigure the GPS receiver to obtain position information more frequently.

The software thread may use a variable timer to determine when to open the communications port to read a next burst of data. The timer value may be based on the actual timings of prior bursts of data from the peripheral device. For example, when the value of a prior two timers are the same, the timer may be set to this same value. The timer value may also be determined by extrapolation, which may be based on trends from past timer values (e.g., when the timer values have been increasing at a steady rate, the timer may be set to a longer value based on the same rate increase). By providing software that can dynamically adapt to changes in the retrieval of data, the portable device may consume power more efficiently.

The software thread may direct the opening and closing of the communications port, calculation of regular and variable timer values, and detection of changes in position information using software. This software may include computer instructions located in any suitable storage medium (e.g., Random Access Memory (RAM), Read Only Memory (ROM), Cache, etc.) The computer instructions used to direct the software thread to perform various tasks may be located in memory 114 (FIG. 1), in a storage medium in processor 106, or any other suitable location.

In some embodiments, for example, a computer may call a read function to attempt to read a large amount of data from a peripheral device via a communications port. The software thread may open the communications port just long enough to read the data burst. Various techniques may be used to detect an end of the read function, including detecting an end-of-frame event, an interval timeout, an overrun error, and a power event. These techniques, sometimes referred to herein as a “detect” function, may be applied as separate embodiments or in combination as one embodiment.

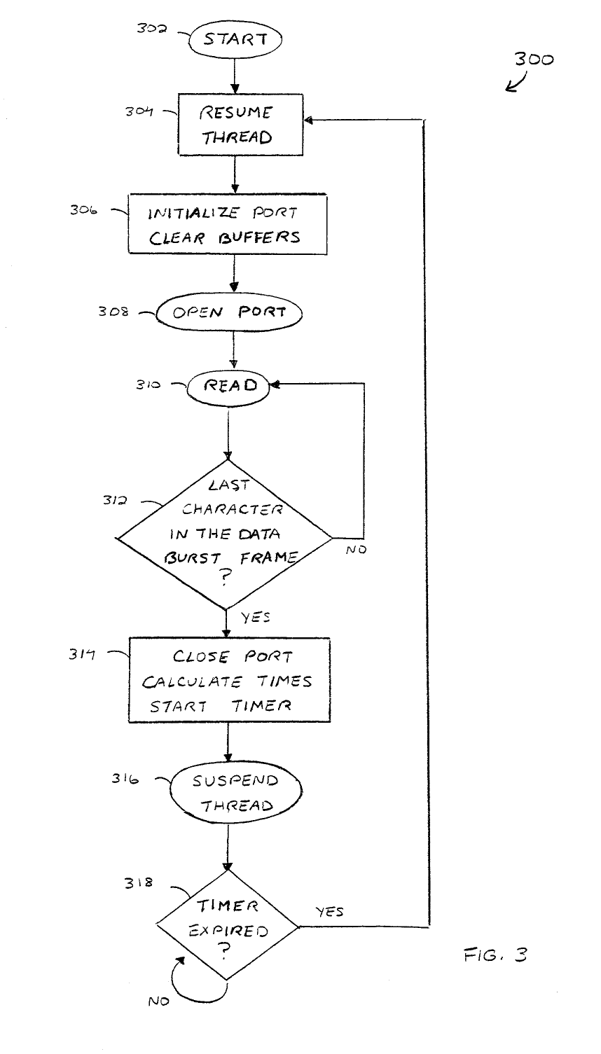

In some embodiments, a detect function may signal when an “end-of-frame” is received. An illustrative method for detecting an end-of frame event is shown in FIG. 3. An end-of-frame indicates an end of a data burst. This embodiment may be used when the size of a data burst frame (a fixed number of characters in the data burst frame) is known. The size of the data burst may be known prior to transmission of the data burst, the size may be provided with the beginning of the data burst, or the size may be learned (e.g., by examining the first burst or every predefined number of bursts). Process 300 begins at step 302. At step 304, a software thread is initiated. In preparation for receiving data from a peripheral device, the communications port is initialized and any buffers are cleared at step 306. The buffers may be temporary storage units used during the processing and storing of data received from the peripheral device. At step 308, the communications port is opened and process 300 begins reading data sent from the peripheral device at step 310. While process 300 illustrates the data being read serially (i.e., a character at a time), the data may be read any other suitable way. At step 312, process 300 determines whether the last character in the data burst frame has been read. When the last character has not been read, process 300 returns to step 310 to read another character. When the last character has been read, an end-of-frame has been detected and process 300 proceeds to step 314 where the communications port is closed and the burst of data completes processing. Also at step 314, a timer value may be calculated and the timer started. The software thread is then suspended at step 316. At step 318, process 300 determines whether the timer has expired. When the timer has not expired, the software thread remains suspended at step 318. When the timer has expired, process 300 returns to step 304 where the software thread resumes and the process to read a next burst of data begins. Significant power savings may be achieved because the communications port can be closed immediately after reading a last character in the data burst frame.

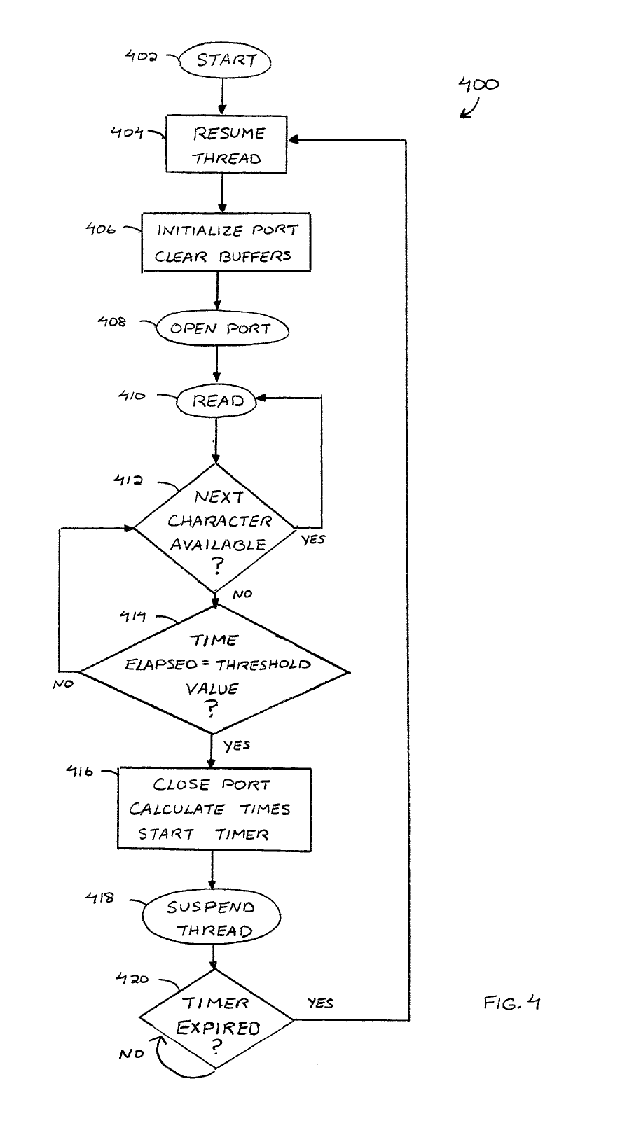

In some embodiments, a detect function may signal when an “interval timeout” occurs. An illustrative method for detecting an interval timeout is shown in FIG. 4. An interval timeout occurs when the time interval between two successive character transmissions exceeds a predetermined time interval (e.g., 50 milliseconds), indicating an end of the data burst. This embodiment may be used regardless of whether the size of a data burst frame is known. Process 400 begins at step 402. At step 404, a software thread is initiated. In preparation for receiving data from a peripheral device, the communications port is initialized and any buffers are cleared at step 406. The buffers may be temporary storage units used during the processing and storing of data received from the peripheral device. At step 408, the communications port is opened and process 400 begins reading data sent from the peripheral device at step 410. After a character is read at step 410, process 400 may determine whether a next character is available at step 412. When another character is available, process 400 returns to step 410 to read another character. When a next character is not available, process 400 proceeds to step 414 where it determines whether the time that has elapsed since a last character read has exceeded the predetermined time interval (or threshold value). When the time interval has not been exceeded, process 400 returns to step 412 to determine whether a next character is available. When the time interval has been exceeded, indicating that the entire data burst has been read (an interval timeout has occurred), process 400 proceeds to step 416 where the communications port is closed and the burst of data completes processing. A timer value may be calculated and the timer started at step 416. The software thread is then suspended at step 418. At step 420, process 400 determines whether the timer has expired. When the timer has not expired, the software thread remains suspended at step 420. When the timer has expired, process 400 proceeds to step 304 where the software thread resumes and the process to read a next burst of data begins.

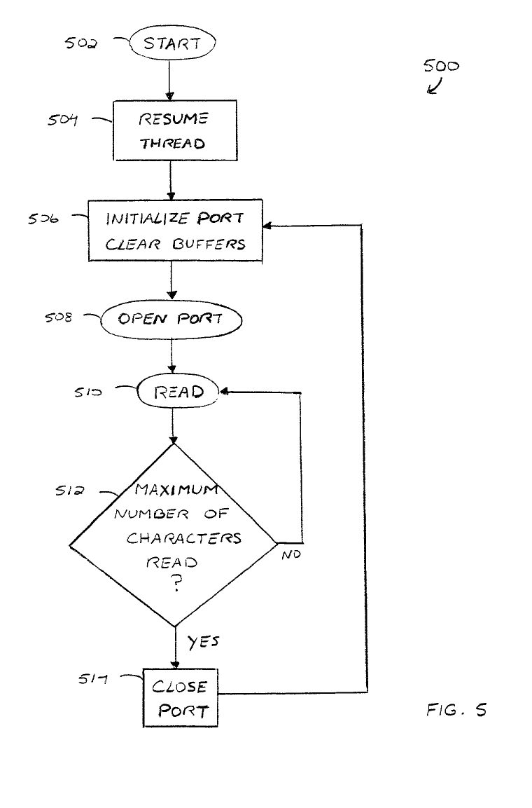

In some embodiments, a detect function may signal when an “overrun error” occurs. An illustrative method for detecting an overrun error is shown in FIG. 5. An overrun error occurs when a number of characters read from the communications port exceeds a predetermined number. This predetermined number may be set to a maximum number of characters that can be stored in the buffers, whose size is limited by the available amount of memory of the portable device. Process 500 begins at step 502. At step 504, a software thread is initiated. In preparation for receiving data from a peripheral device, the communications port is initialized and any buffers are cleared at step 506. The buffers may be temporary storage units used during the processing and storing of data received from the peripheral device. At step 508, the communications port is opened and process 500 begins reading data sent from the peripheral device at step 510. After a character is read at step 510, process 500 may determine whether a maximum number of characters has been read at step 512. When the maximum number of characters has not been read, process 500 returns to step 510 to read another character. Once the maximum number of characters read has been exceeded, an overrun error has occurred and the communications port is closed at step 514. Process 500 then returns to 506 where the communications port is reinitialized and the buffers are cleared before the process for reading the same burst of data begins.

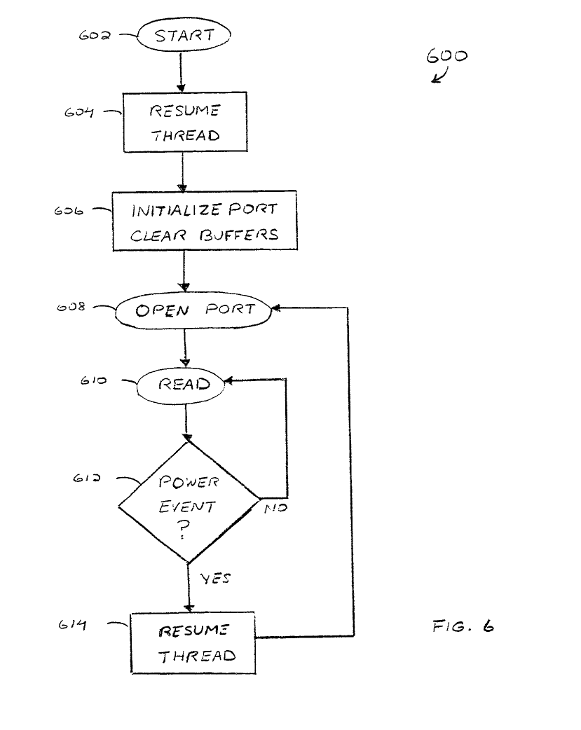

In some embodiments, a detect function may signal when a “power event” occurs. An illustrative method for detecting a power event is shown in FIG. 6. A power event may indicate that the all applications and thread currently running on the computer have suspended and all communications ports have closed, and the portable device has automatically shut down (i.e., turned “OFF” or the power cycle of the portable device entered sleep mode). Once the portable device powers back up (i.e., turns “ON”), programs or activities previously running on the portable device may resume where they last executed. Process 600 begins at step 602. At step 604, a software thread is initiated. In preparation for receiving data from a peripheral device, the communications port is initialized and any buffers are cleared at step 606. The buffers may be temporary storage units used during the processing and storing of data received from the peripheral device. At step 608, the communications port is opened and process 600 begins reading data sent from the peripheral device at step 610. After a character is read at step 610, process 600 may determine whether a power event has occurred. When a power event has not occurred, process 600 returns to step 610 to read another character. When a power event has occurred (e.g., the communications port has closed, the software thread has been suspended, and the computer shut down and has powered back up), process 600 proceeds to step 614 where the software thread resumes. Process 600 then returns to step 608 where the communications port is opened and the process to read the rest of the data burst continues.

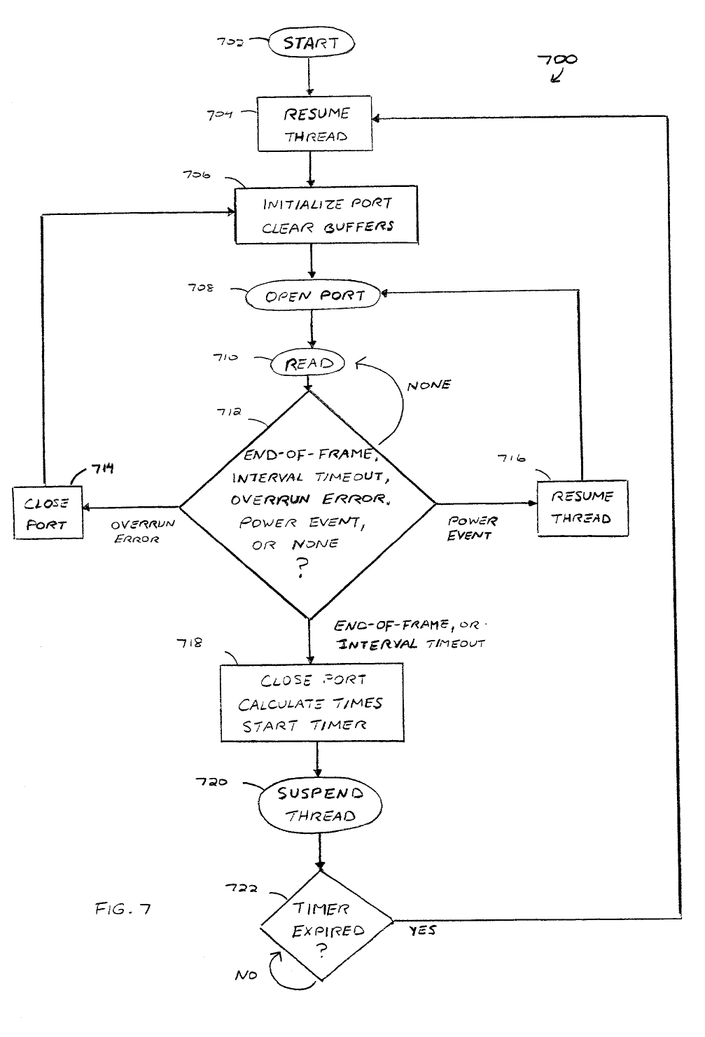

The end-of-frame, interval timeout, overrun error, and power event features may be provided separately in some embodiments and may be combined in other embodiments. For example, FIG. 7 illustrates a process 700 of a detect function that signals a end-of-frame event, an interval timeout, an overrun error, or a power event, in accordance with one embodiment of the present invention. Process 700 begins at step 702. At step 704, a software thread is initiated. In preparation for receiving data from a peripheral device, the communications port is initialized and any buffers are cleared at step 706. The buffers may be temporary storage units used during the processing and storing of data received from the peripheral device. At step 708, the communications port is opened and process 700 begins reading data sent from the peripheral device at step 710. After a character is read at step 710, process 700 may determine whether an overrun error, a power event, an end-of-frame event, or an interval timeout has occurred. When none of these has occurred, process 700 returns to step 710 to read another character. When an overrun error is detected, process 700 proceeds to step 714 where the communications port is closed. Process 700 then returns to step 706 where the communications port is reinitialized and the buffers are cleared before the process for reading the same burst of data begins. When a power event is detected, process 700 proceeds to step 716 where the software thread resumes. Process 700 then returns to step 708 where the communications port is opened and the process to read the rest of the data burst continues. When an end-of-frame event or interval timeout is detected, process 700 proceeds to step 718 where the communications port is closed and the burst of data completes processing. Also at step 718, a timer value may be calculated and the timer started. The software thread is then suspended at step 720. At step 722, process 700 determines whether the timer has expired. When the timer has not expired, the software remains suspended at step 722. When the timer has thread, process 700 returns to step 704 where the software thread resumes and the process to read a next burst of data begins.

Thus it can be seen that power consumption in devices that communicate with peripheral devices may be reduced. One skilled in the art will appreciate that the present invention can be practiced by other than the described embodiments, which are presented for purposes of illustration and not of limitation, and the present invention is limited only by the claims which follow.

What is claimed is:

1. A method for reducing power consumption in a portable device that communicates with a peripheral device, the method comprising:
opening a communications port on the portable device;
receiving data from the peripheral device;
detecting a terminating character in the data on the portable device; and
closing the communications port in response to detecting the terminating character in the data.

2. The method of claim 1 further comprising initiating a software thread prior to opening the communications port, wherein the software thread manages the communications port.

3. The method of claim 1 further comprising:
initializing the communications port prior to opening the communications port; and
clearing all buffers prior to opening the communications port.

4. The method of claim 1 wherein. detecting the terminating character in the data comprises receiving a value prior to receiving the data, wherein. the value is a fixed number of characters in the data.

5. The method of claim 1 wherein. detecting the terminating character in the data comprises receiving a value with a beginning of the data, wherein the value is a fixed number of characters in the data.

6. The method of claim 1 further comprising:
determining a time until a next data is to be received; and
suspending a software thread until the determined time has passed.

7. The method of claim 6 further comprising:
resuming the software thread once the determined time has passed; and
reopening the communications port to receive the next data.

8. A method for reducing power consumption in a portable device that communicates with a peripheral device, the method comprising:
opening a communications port on the portable device;
receiving data from the peripheral device;
detecting when a predetermined time interval between two successive characters in the data is exceeded on the portable device; and
closing the communications port in response to detecting when the predetermined time interval is exceeded.

9. The method of claim 8 further comprising initiating a software thread prior to opening the communications port, wherein the software thread manages the communications port.

10. The method of claim 8 further comprising:
initializing the communications port prior to opening the communications port; and
clearing all buffers prior to opening the communications port.

11. The method of claim 8 further comprising:
determining a time until a next data is to be received; and
suspending a software thread until the determined time has passed.

12. The method of claim 11 further comprising:
resuming the software thread once the determined time has passed; and
reopening the communications port to receive the next data.

13. A method for reducing power consumption in a portable device that communicates with a peripheral device, the method comprising:
opening a communications port on the portable device;
receiving data from the peripheral device;
detecting an end of the data on the portable device;
closing the communications port in response to detecting the end of the data;
determining a time until the communications port is to be reopened; and
reopening the communications port at the determined time.

14. The method of claim 13 further comprising initiating a software thread prior to opening the communications port, wherein the software thread manages the communications port.

15. The method of claim 13 wherein detecting the end of the data comprises one of:
detecting a terminating character in the data; and
detecting when a predetermined time interval between two characters in the data is exceeded.

16. The method of claim 13 wherein determining the time until the communications port is to be reopened comprises:
determining a time until a next data is to be received; and
suspending a software thread until the determined time has passed.

17. The method of claim 16 wherein determining the time further comprises subtracting a data time from a time period, wherein:
the time period is a time difference between two successive times when ends of data are detected; and
the data time is a number of characters read in the data divided by a baud rate of the data frame, wherein the baud rate is a number of characters transmitted per second.

18. The method of claim 16 wherein determining the time comprises determining the time after an initial data is received and assigning the same time after receiving each subsequent data.

19. The method of claim 16 wherein determining the time further comprises extrapolating a time based on determined times from prior data.

20. The method of claim 16 further comprising resuming the software thread once the determined time has passed.

21. The method of claim 13 wherein determining the time until the communications port is to be reopened further comprises:
detecting a change in position between two data that exceeds a predetermined range; and
reconfiguring the peripheral device to transmit data at a different frequency in which the change in position between two data is in the predetermined range.

22. A method for reducing power consumption in a portable device that communicates with a peripheral device, the method comprising:
opening a communications port on the portable device;
receiving data from the peripheral device;
detecting (i) a terminating character in the data, (ii) when a predetermined time interval between two characters in the data is exceeded, or (iii) when a predetermined number of characters in the data is exceeded, wherein the predetermined number of characters is a maximum number of characters that can be received by the portable device on the portable device; and
closing the communications port in response to detecting (i) the terminating character in the data, (ii) when the predetermined time interval between two characters in the data is exceeded, or (iii) when the predetermined number of characters in the data is exceeded.

23. The method of claim 22 further comprising initiating a software thread prior to opening the communications port, wherein the software thread manages the communications port.

24. The method of claim 22 further comprising:
initializing the communications port prior to opening the communications port; and
clearing all buffers prior to opening the communications port.

25. The method of claim 22 wherein closing the communications port in response to (i) detecting the terminating character in the data or (ii) detecting when the predetermined time interval between two characters in the data is exceeded further comprises:
determining a time until a next data is to be received; and
suspending a software thread until the determined time has passed.

26. The method of claim 25 further comprising:
resuming the software thread once the determined time has passed; and
reopening the communications port to receive the next data.

27. The method of claim 22 wherein closing the communications port in response to detecting when the predetermined number of characters in the data is exceeded further comprises:
initializing the communications port;
clearing all buffers in the communications port;
opening the communications port; and
receiving the data.

28. The method of claim 22 further comprising detecting a power shutdown, wherein the power shutdown comprises:
closing the communications port;
suspending a software thread after the communications port is closed;
entering a sleep mode after the software thread is suspended; and
waking from the sleep mode.

29. The method of claim 28 further comprising: resuming the software thread after waking from the sleep mode;
reopening the communications port after the software thread is resumed; and
receiving a rest of the data until (i) the terminating character in the data is detected, (ii) the predetermined time interval between two characters in the data is exceeded, or (iii) the predetermined number of characters in the data is exceeded.

30. A system for reducing power consumption in a portable device that communicates with a peripheral device, the system comprising:
means for opening a communications port on the portable device;
means for receiving data from the peripheral device;
means for detecting a terminating character in the data on the portable device; and
means for closing the communications port in response to detecting the terminating character in the data.

31. The system of claim 30 further comprising means for initiating a software thread prior to opening the communications port, wherein the software thread manages the communications port.

32. The system of claim 30 further comprising:
means for initializing the communications port prior to opening the communications port; and
means for clearing all buffers prior to opening the communications port.

33. The system of claim 30 wherein the means for detecting the terminating character in the data comprises means for receiving a value prior to receiving the data, wherein the value is a fixed number of characters in the data.

34. The system of claim 30 wherein the means for detecting the terminating character in the data comprises means for receiving a value with a beginning of the data, wherein the value is a fixed number of characters in the data.

35. The system of claim 30 further comprising:
means for determining a time until a next data is to be received; and
means for suspending a software thread until the determined time has passed.

36. The system of claim 35 further comprising:
means for resuming the software thread once the determined time has passed; and
means for reopening the communications port to receive the next data.

37. A system for reducing power consumption in a portable device that communicates with a peripheral device, the system comprising:
means for opening a communications port on the portable device;
means for receiving data from the peripheral device;
means for detecting when a predetermined time interval between two successive characters in the data is exceeded on the portable device; and
means for closing the communications port in response to detecting when the predetermined time interval is exceeded.

38. The system of claim 37 further comprising means for initiating a software thread prior to opening the communications port, wherein the software thread manages the communications port.

39. The system of claim 37 further comprising:
means for initializing the communications port prior to opening the communications port; and
means for clearing all buffers prior to opening the communications port.

40. The system of claim 37 further comprising:
means for determining a time until a next data is to be received; and
means for suspending a software thread until the determined time has passed.

41. The system of claim 40 further comprising:
means for resuming the software thread once the determined time has passed; and
means for reopening the communications port to receive the next data.

42. A system for reducing power consumption in a portable device that communicates with a peripheral device, the system comprising:
means for opening a communications port on the portable device;
means for receiving data from the peripheral device;
means for detecting an end of the data on the portable device;
means for closing the communications port in response to detecting the end of the data;
means for determining a time until the communications port is to be reopened; and
means for reopening the communications port at the determined time.

43. The system of claim 42 further comprising means for initiating a software thread prior to opening the communications port, wherein the software thread manages the communications port.

44. The system of claim 42 wherein the means for detecting the end of the data comprises one of:
means for detecting a terminating character in the data; and
means for detecting when a predetermined time interval between two characters in the data is exceeded.

45. The system of claim 42 wherein the means for determining the time until the communications port is to be reopened comprises:
means for determining a time until a next data is to be received; and
means for suspending a software thread until the determined time has passed.

46. The system of claim 45 wherein the means for determining the time further comprises means for subtracting a data time from a time period, wherein:
the time period is a time difference between two successive times when ends of data are detected; and
the data time is a number of characters read in the data divided by a baud rate of the data frame, wherein the baud rate is a number of characters transmitted per second.

47. The system of claim 45 wherein the means for determining the time comprises means for determining the time after an initial data is received and means for assigning the same time after receiving each subsequent data.

48. The system of claim 45 wherein the means for determining the time further comprises means for extrapolating a time based on determined times from prior data.

49. The system of claim 45 further comprising means for resuming the software thread once the determined time has passed.

50. The system of claim 42 wherein the means for determining the time until the communications port is to be reopened further comprises:
means for detecting a change in position between two data that exceeds a predetermined range; and
means for reconfiguring the peripheral device to transmit data at a different frequency in which the change in position between two data is in the predetermined range.

51. A system for reducing power consumption in a portable device that communicates with a peripheral device, the system comprising:
means for opening a communications port on the portable device;
means for receiving data from the peripheral device;
means for detecting (i) a terminating character in the data, (ii) when a predetermined time interval between two characters in the data is exceeded, or (iii) when a predetermined number of characters in the data is exceeded, wherein the predetermined number of characters is a maximum number of characters that can be received by the portable device on the portable device; and
means for closing the communications port in response to the means for detecting (i) the terminating character in the data, (ii) when the predetermined time interval between two characters in the data is exceeded, or (iii) when the predetermined number of characters in the data is exceeded.

52. The system of claim 51 further comprising means for initiating a software thread prior to opening the communications port, wherein the software thread manages the communications port.

53. The system of claim 51 further comprising:
means for initializing the communications port prior to opening the communications port; and
means for clearing all buffers prior to opening the communications port.

54. The system of claim 51 wherein the means for closing the communications port in response to (i) the means for detecting the terminating character in the data or (ii) the means for detecting when the predetermined time interval between two characters in the data is exceeded further comprises:
means for determining a time until a next data is to be received; and
means for suspending a software thread until the determined time has passed.

55. The system of claim 54 further comprising:
means for resuming the software thread once the determined time has passed; and
means for reopening the communications port to receive the next data.

56. The system of claim 51 wherein the means for closing the communications port in response to the means for detecting when the predetermined number of characters in the data is exceeded further comprises:
means for initializing the communications port;
means for clearing all buffers in the communications port;
means for opening the communications port; and
means for receiving the data.

57. The system of claim 51 further comprising means for detecting a power shutdown, wherein the power shutdown comprises:
means for closing the communications port;
means for suspending a software thread after the communications port is closed;
means for entering a sleep mode after the software thread is suspended; and
means for waking from the sleep mode.

58. The system of claim 57 further comprising:
means for resuming the software thread after waking from the sleep mode;
means for reopening the communications port after the software thread is resumed; and
means for receiving a rest of the data until (i) the terminating character in the data is detected, (ii) the predetermined time interval between two characters in the data is exceeded, or (iii) the predetermined number of characters in the data is exceeded.
